(19) United States
(12) Patent Application Publication
(10) Pub. No.: US 2015/0093200 A1
(43) Pub. Date: Apr. 2, 2015

(54) METHOD AND APPARATUS FOR CLEANING A PIPE LENGTH

(71) Applicant: SAIPEM S.P.A., Milan (IT)

(72) Inventors: Andelko Marusic, Milan (IT); Fabrizio Martini, Milan (IT)

(21) Appl. No.: 14/398,226

(22) PCT Filed: May 2, 2013
(86) PCT No.: PCT/EP2013/059136

§ 371 Date: Oct. 31, 2014

(30) Foreign Application Priority Data
May 2, 2012 (GB) 1207699.8

(51) Int. Cl. B08B 9/049; F16L 1/26; B63B 35/03

(52) U.S. Cl. CPC B08B 9/049; B63B 35/03; F16L 1/26
USPC 405/184.1; 134/8; 134/22.11; 134/18; 15/104.05; 15/408

(57) ABSTRACT

To clean the inside of a pipe length a swabbing machine is provided at a first end of the pipe length, the swabbing machine includes a pneumatic motor and is propelled along the inside of the pipe length in a first direction away from the first end of the pipe length by the pneumatic motor. A swabbing machine and a swabbing machine system are also disclosed.

### TECHNICAL FIELD

The present invention relates to a method and apparatus for cleaning the inside of a pipe length comprising at least one welded joint, and especially, but not exclusively to a method and apparatus for cleaning the inside of a pipe length suitable for laying as part of a pipeline for use in the offshore oil and gas industry.

### BACKGROUND OF THE INVENTION

One of the tasks that are carried out by certain vessels in the offshore industry is that of laying pipelines. Commonly, pipe sections are joined into longer pipe lengths onboard such vessels and the longer lengths are then welded to the continuous pipeline as it is laid.

Pipe sections are welded together to form pipe lengths in the prefabrication area of the pipelaying vessel. Following the welding, the inside of each pipe length is cleaned and the quality of the weld inspected using Non-Destructive Testing (NDT) methods. The pipe length is then transferred to the firing line where it is cleaned again before being welded to the continuous pipeline.

Typically cleaning with pressurised air is carried out manually in the prefabrication area before a rubber swabbing ring is passed through the pipe length once it has been moved to the firing line. The amount of human intervention required, and the need to clean the pipe both in the prefabrication area and the firing line, renders the pipe cleaning method excessively time consuming.

Other methods of pipe cleaning involve passing a cleaning apparatus through the inside of a pipe length typically by either (i) pushing cleaning apparatus through the pipe using high pressure fluid or (ii) pulling the cleaning apparatus through the pipe using a winch. In U.S. Pat. No. 4,011,100A a cleaning apparatus is disclosed where fluid is supplied under pressure in the pipe to propel the apparatus through the pipe. In US 2008/0141474 a pig cleaning device adapted to be dragged by a pig towing device is disclosed.

It is an object of the invention to provide an improved method of cleaning the inside of a pipe length and a swabbing machine for cleaning the inside of a pipe length.

### SUMMARY OF THE INVENTION

According to a first aspect of the invention there is provided a method of cleaning the inside of a pipe length comprising at least one welded joint wherein the method comprises:

providing a swabbing machine at a first end of the pipe length, and

propelling the swabbing machine along the inside of the pipe length in a first direction away from the first end of the pipe length,

wherein the swabbing machine comprises a motor and the swabbing machine is propelled in the first direction by the motor.

Propelling the swabbing machine with a motor which is onboard the machine itself removes the need for winching the machine or pressurising the entire pipe length as is done in the conventional methods described above. Thus the swabbing machine is self-propelled.

The motor may be, for example, an electric motor, a hydraulic motor or a pneumatic motor. Preferably the motor is a pneumatic motor or a hydraulic motor. Use of a pneumatic motor or a hydraulic motor as opposed to, for example, an electric motor allows the swabbing machine to travel in the pipe length while Non-Destructive Testing (NDT) of the weld joint is on-going. A pneumatic motor is especially preferred. Pneumatic motors may be advantageous in that they can be supplied by air, for example, from a compressor.

The welded joint may have been formed using a Metal Inert Gas (MIG) or a Metal Active Gas (MAG) welding process. The pipe length may be made from a number of individual pipe sections joined together. A pipe length may be 24 meters, 36 meters or 48 meters in length. Debris to be cleaned from the inside of the pipe length may include dust, surplus welding flux and/or slag produced by Submerged Arc Welding.

Advantageously the swabbing machine can be returned to the position from which it started. In that way, any operator input may only be required at one end of the pipe length, which may reduce manpower requirements and leave the other end of the pipe length free for other operations. Advantageously the swabbing machine can propel itself back along the pipe length in the same way as it propelled itself in the first direction.

Thus, the method may comprise:

propelling the swabbing machine along the inside of the pipe length in a second direction, opposite to the first direction,

wherein the swabbing machine is propelled in the second direction by the motor. Thus, the swabbing machine may be self-propelled in either direction along the longitudinal axis of the pipe length.

The pipe length has a first end at which the swabbing machine is provided to the pipe and a second end opposite the first end. The first direction may be away from the first end of the pipe length toward the second end of the pipe length along the longitudinal axis of the pipe length. The second direction may be away from the second end of the pipe length toward the first end of the pipe length along the longitudinal axis of the pipe length.

The method may comprise:

propelling the swabbing machine along the inside of the pipe length, in the first direction, from the first end of the pipe length to the second end of the pipe length, and

propelling the swabbing machine along the inside of the pipe length, in the second direction, from the second end of the pipe length to the first end of the pipe length,

wherein the swabbing machine comprises a sensor which detects the swabbing machine reaching the second end of the pipe. Thus, the swabbing machine returns to the first end of the pipe length after cleaning the entire pipe length.

The sensor may be a proximity sensor.

The swabbing machine may comprise a logic system which switches the direction in which the pneumatic motor propels the swabbing machine from the first direction to the second direction in response to a signal from the sensor. The combination of the logic system and sensor allows the swabbing machine to change direction when it reaches the end of the pipe length without input from an operator.

The sensor is advantageously a pneumatic sensor or a hydraulic sensor. A pneumatic sensor is especially preferred. The logic system is preferably a pneumatic logic system or a hydraulic logic system. A pneumatic logic system is especially preferred. The provision of such a sensor and logic system may allow the swabbing machine to have no electrical components, which may mean that the swabbing machine can be inside the pipe length when non-destructive testing takes place.

The swabbing machine may clean the inside of the pipe length when travelling in the second direction.

Preferably, the swabbing machine cleans with one or more of a scraper, a brush and a pneumatic blower. These may be used individually or in combination. For example a brush and a scraper may be used with several pneumatic blowers. The pneumatic blowers may be moveable; for example, the direction in which they point may be changed by the logic system during the cleaning process.

The swabbing machine may be provided in a garage and the method may comprise:

aligning the garage with the first end of the pipe length prior to propelling the swabbing machine in the first direction out of the garage and along the inside of the pipe length. Thus, the swabbing machine may propel itself from the garage into the pipe length.

The method may comprise:

propelling the swabbing machine into the garage from the first end of the pipe after propelling the swabbing machine along the inside of the pipe length, in the second direction, from the second end of the pipe length to the first end of the pipe length. Thus, the swabbing machine may propel itself from the pipe length into the garage. For example, the swabbing machine may return to the garage from which it started at the end of the cleaning cycle. The cleaning cycle may take more than 3 minutes and less than 9 minutes to complete.

The method may comprise the step of generating suction at the first end of the pipe length while propelling the swabbing machine in the first direction. The method may comprise the step of generating suction at the first end of the pipe length while propelling the swabbing machine in the second direction. Due to the motor onboard the swabbing machine, suction may be generated at the first end of the pipe length throughout the duration of the cleaning cycle.

The pipe length to be cleaned may be substantially horizontal. The method may be carried out while the pipe is located in a prefabrication area of a pipelaying vessel. For example, the method may be used on a pipe length prior to an S-lay or a J-lay operation provided that the pipe length is horizontal when it is being cleaned. Advantageously the pipe length may be cleaned while a second pipe length is being laid, thus increasing the efficiency of the process.

After two pipe sections have been joined together it is necessary to check the integrity of the weld. A substantial portion of the pipe cleaning method may be executed simultaneously with Non-Destructive Testing (NDT) of the at least one welded joint. Thus, the overall time taken for the cleaning and NDT testing processes is reduced compared to when they are carried out sequentially.

The swabbing machine may travel at a first speed in the first direction and a second speed in the second direction, the first speed being greater than the second speed. Preferably, when travelling along the pipe away from the garage, the cleaning apparatus is not engaged with the inside surface of the pipe length and therefore the swabbing machine may travel faster than on the return leg when the swabbing machine cleans the inside surface of the pipe length. The speed of travel in the first direction may be more than 13 meters per minute but less than 17 meters per minute. The speed of travel in the second direction may be more than 8 meters per minute but less than 13 meters per minute.

According to a second aspect of the invention there is provided a swabbing machine for cleaning the inside of a pipe length including at least one welded joint characterised in that the swabbing machine comprises a motor arranged to propel the swabbing machine when the swabbing machine is inside the pipe length.

The motor may be operable to propel the swabbing machine in a first direction and a second, opposite direction, along the pipe length.

The motor may be, for example, an electric motor, a hydraulic motor or a pneumatic motor. Preferably the motor is a pneumatic motor or a hydraulic motor. Use of a pneumatic motor or a hydraulic motor as opposed to, for example, an electric motor allows the swabbing machine to travel in the pipe length while Non-Destructive Testing (NDT) of the weld joint is on-going. A pneumatic motor is especially preferred.

The swabbing machine may weigh more than 80 kg but less than 200 kg. Advantageously the swabbing machine may weigh more than 120 kg but less than 160 kg.

The swabbing machine uses the motor to propel itself along inside the pipe length. The swabbing machine may comprise at least one wheel operably connected to the motor and operable to engage with the inside of the pipe length so that the motor drives the at least one wheel to propel the swabbing machine.

The swabbing machine may include free-wheeling casters to support the weight of the swabbing machine. A single driven wheel may be provided. Thus, the swabbing machine may roll along the inside of the pipe length on the casters as a result of being driven by the single wheel. In a preferred embodiment two sets of casters and a single driven wheel are provided. Each set of casters and the driven wheel are separated one from the other by an angle of 120 degrees about the longitudinal axis of the swabbing machine.

The swabbing machine cleans the inside of the pipe surface by removing waste from the welding process which may have accumulated there. The waste may be stuck to the inside of the pipe surface and may need to be loosened using mechanical means. Once loosened the waste must also be removed from inside the pipe. The swabbing machine may comprise a number of cleaning tools operable to clean the inside of the pipe length. Cleaning tools may include one or more of at least one scraper, at least one brush, at least one pneumatic blower.

The swabbing machine may comprise a combination of cleaning tools. For example, the swabbing machine may comprise at least one scraper, at least one brush and at least one pneumatic blower. The pneumatic blowers may be moveable.

The swabbing machine may comprise a logic system arranged to control the direction of travel of the swabbing machine. Thus, the logic system may be operable to switch the direction of travel from the first direction to the second direction.

The logic system may comprise a sensor, for example a proximity sensor, arranged to detect when the swabbing machine has reached the distal end of the pipe length. Thus, the logic system may be operable to switch the direction of travel from the first direction to the second direction in response to a signal from the sensor. Switching the direction of travel in response to a signal from the sensor reduces the need for operator input during the cleaning process.

The logic system may be arranged to control the speed of travel of the swabbing machine within the pipe length. Thus, the speed of the swabbing machine may be adjustable to suit the requirements of a particular step of the method.

Having the cleaning apparatus engaged with the side of the pipe generates increased resistance which the motor must overcome in order to drive the swabbing machine along the pipe length. The logic system may be arranged to control the engagement and disengagement of the cleaning apparatus with the inside of the pipe. Thus, the cleaning apparatus is only engaged with the inner surface of the pipe length during the cleaning step, preferably as the swabbing machine returns to the first end of the pipe length, thereby reducing the energy required to propel the swabbing machine during the cleaning cycle as a whole. An additional advantage of this arrangement is that debris is not moved along the inside of the pipe length by the cleaning apparatus when the swabbing machine is travelling in the first direction.

The sensor is advantageously a pneumatic sensor or a hydraulic sensor. A pneumatic sensor is especially preferred. The logic system is preferably a pneumatic logic system or a hydraulic logic system. A pneumatic logic system is especially preferred. The provision of such a sensor and logic system may allow the swabbing machine to have no electrical components, which may mean that the swabbing machine can be inside the pipe length when non-destructive testing takes place.

The swabbing machine may form part of a larger swabbing machine system for cleaning the inside of a pipe length having at least one welded joint. The swabbing machine system may comprise:

a swabbing machine according to the present aspect, and

a swabbing machine garage for holding the swabbing machine when not in use, and

a drive system arranged to move the garage, so as to align the garage with the end of the pipe length so that the swabbing machine can be delivered to the pipe length.

The swabbing machine system may comprise at least one sensor arranged to detect the location of the pipe length relative to the garage. The sensor may be a photo-cell. The swabbing machine system may comprise a control system arranged to control the drive system of the garage in response to inputs from the sensor. Thus the garage may be aligned with the end of the pipe length and the swabbing machine inside the garage may be delivered to the pipe length to be cleaned without any input from an operator.

The swabbing machine cleans the inside surface of the pipe length as it travels in the second direction back towards the first end where the garage is located. The swabbing machine system may comprise an aspirator connected to the garage so as to provide suction at the end of the pipe length. Thus, the debris removed from the inside surface of the pipe length, and pushed ahead of the swabbing machine by the cleaning apparatus, is removed from inside the pipe. By connecting the aspirator to the garage, the need for forming a separate connection to the pipe length for the aspirator is removed, which may reduce the time taken to carry out the cleaning.

The swabbing machine system may comprise a filter system arranged to extract waste particles from the gas extracted from inside the pipe by the aspirator. Thus, the exhaust from the filter system may be returned back to the environment.

The motor may be a pneumatic motor and the swabbing machine system may comprise:

a hose connected to the swabbing machine so as to deliver a supply of pressurised gas to the pneumatic motor. The pressurised gas may be air. The air may be taken from the environment and pressurised using a compressor. Thus, air may be supplied direct to the swabbing machine and aspiration may be applied to generate suction at the first end of the pipe length while the swabbing machine travels in the first direction without compromising the supply of air to the pneumatic motor. Air may be supplied to the swabbing machine at a rate of more than 3000 litres per minute but less than 4000 litres per minute. The diameter of the hose may be more than 1.5 centimetres but less than 3.0 centimetres.

An advantage of using a pneumatic motor or hydraulic motor and a pneumatic control system or hydraulic control system instead, for example of an electric motor or electronic control system, is that the swabbing machine can be in the pipe when NDT is carried out. Carrying our NDT and cleaning simultaneously may result in a significant time saving. Thus, according to a broad aspect of the invention there is provided a swabbing machine for cleaning the inside of a pipe length, the swabbing machine comprising a pneumatic motor or a hydraulic and a pneumatic control system or a hydraulic control system, and wherein the swabbing machine does not comprise any electronic components. A pneumatic motor and pneumatic control system are especially preferred. The absence of electronic components allows Life swabbing machine to travel inside the pipe length while NDT of the weld joint is on-going.

According to a further aspect of the invention there is provided a pipe-laying vessel, equipped with a swabbing machine or swabbing machine system as described above.

Any features described with reference to one aspect of the invention are equally applicable to any other aspect of the invention, and vice versa. For example, any features described with reference to the swabbing machine of the invention are equally applicable to the method.

### DESCRIPTION OF THE DRAWINGS

Various embodiments of the invention will now be described, by way of example only, with reference to the accompanying schematic drawings of which:

FIGS. 1a and 1b are perspective views of a swabbing machine system in accordance with a first embodiment of the invention;

FIG. 2 is a sectional schematic view of a swabbing machine inside a garage in accordance with the first embodiment;

FIGS. 3a and 3b are perspective views of a swabbing machine of the first embodiment;

FIG. 4 is a close up perspective view of part of a swabbing machine of the first embodiment;

FIG. 5 is a close up of part of a swabbing machine system of the first embodiment.

### DETAILED DESCRIPTION

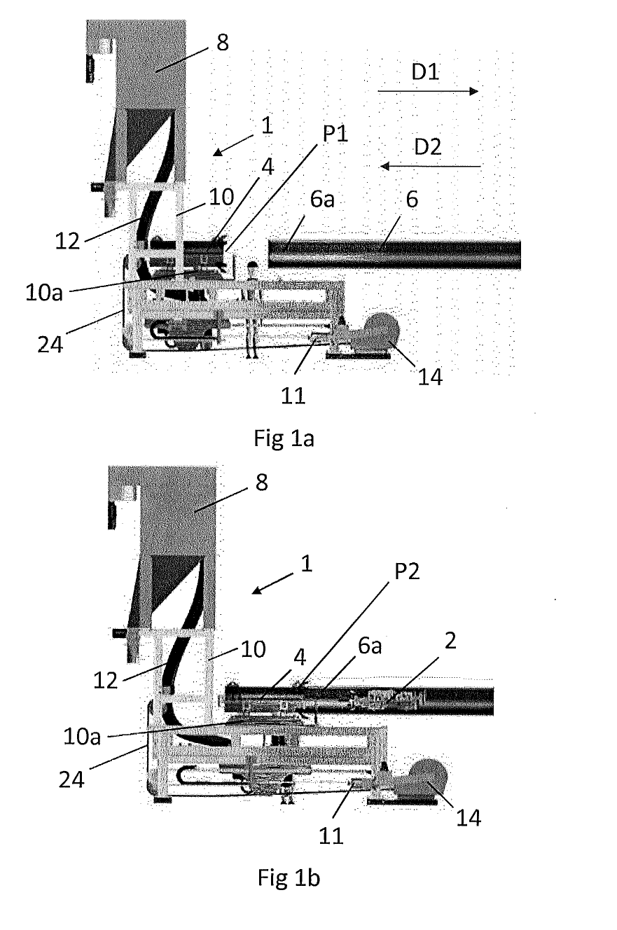

In FIG. 1a a swabbing machine system 1 is adjacent to a pipe length 6 to be cleaned. The swabbing machine system 1 consists of a cylindrical garage 4, open at the end proximate to the pipe and closed at the end distal to the pipe, supported on a frame 10. The swabbing machine (not shown) is located inside the garage 4 in FIG. 1a. An aspirator 8 is also supported by the frame 10 and is located above the garage 4. An aspirator hose 12 connects the aspirator 8 to the underside of the garage 4. A drive 11 is attached to the garage support frame 10a which is moveable relative to the main frame 10. The drive 11 moves the garage 4 relative to the pipe length 6. One end of a hose 24 is attached to the swabbing machine and passes through the back of the garage 4 and the other end is wound around a hose reel 14 adjacent to the frame.

When the cleaning cycle begins the garage 4 is moved by the drive 11 from the starting position P1 in FIG. 1a into alignment with the pipe length 6 (Position P2) as in FIG. 1b. This allows the swabbing machine 2 to be propelled out of the garage 4 and into the pipe length 6. In FIG. 1b the swabbing machine 2 is inside the pipe length 6.

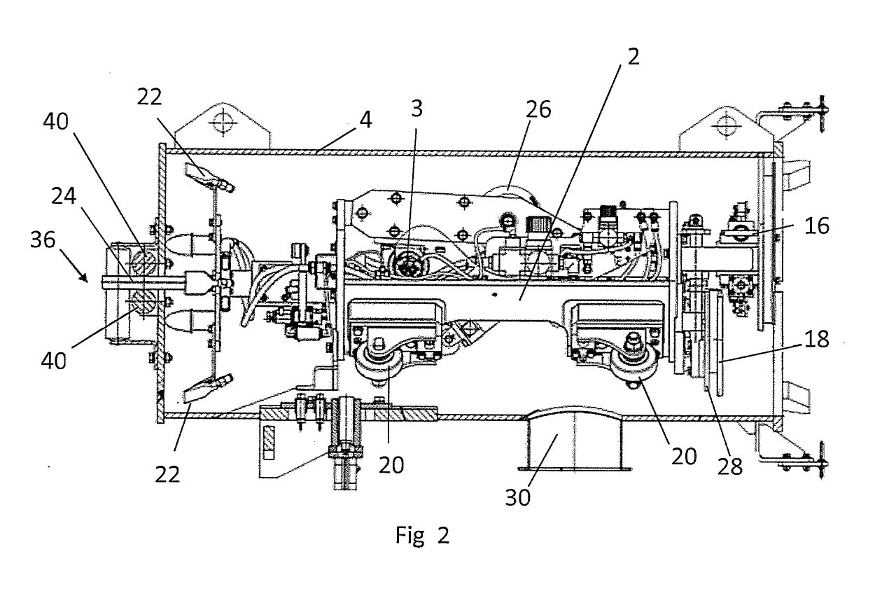

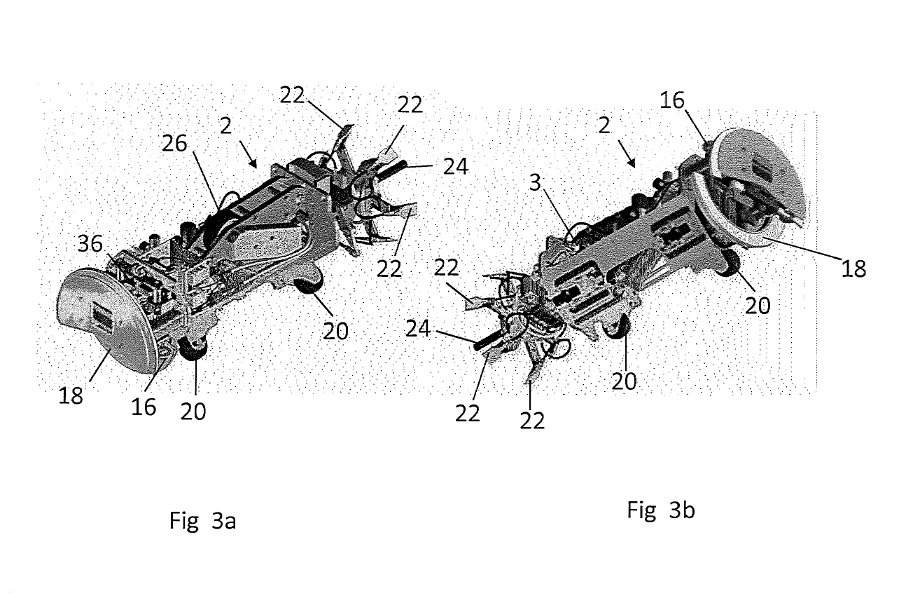

FIG. 2 is a sectional schematic view of the swabbing machine 2 inside the garage 4 and FIGS. 3a and 3b are perspective views of the swabbing machine 2. The swabbing machine has a pneumatic motor 3 which drives a wheel 26 mounted on the swabbing machine (disengaged from the inside of the garage in FIG. 2). The pressurised air supply for the pneumatic motor 3 is provided to the swabbing machine 2 by the hose 24 which passes through a small opening 36 in the distal end of the garage 4. Rollers 40 at the opening 36 allow the hose 24 to pass freely through the opening 36.

Two sets of two freewheeling casters 20 (four casters in total) located on the underside of the swabbing machine 2 support the weight of the swabbing machine 2 and allow it to be propelled along the inside of the pipe length 6. The two sets of freewheeling casters 20 and the driven wheel 26 are separated by an angle of 120 degrees about the longitudinal axis of the swabbing machine 2. The casters 20 in combination with the driven wheel 26 act to keep the longitudinal axis of the swabbing machine 2 parallel to the longitudinal axis of the pipe length 6.

Once the garage 4 has been aligned with the first end of the pipe length 6a, suction is provided by the aspirator 8 to the garage 4 and compressed air is supplied to the swabbing machine 2 via the hose 24. The driven wheel 26 is then engaged with the inside surface of the garage 4 and the swabbing machine 2 is propelled into the pipe by the pneumatic motor 3. The swabbing machine 2 then continues along the inside of the pipe length in a first direction D1 indicated by the arrow in FIG. 1a.

As the swabbing machine 2 travels inside the pipe length 6 in direction D1 the hose 24 which is attached to the swabbing machine unwinds from the hose reel 14.

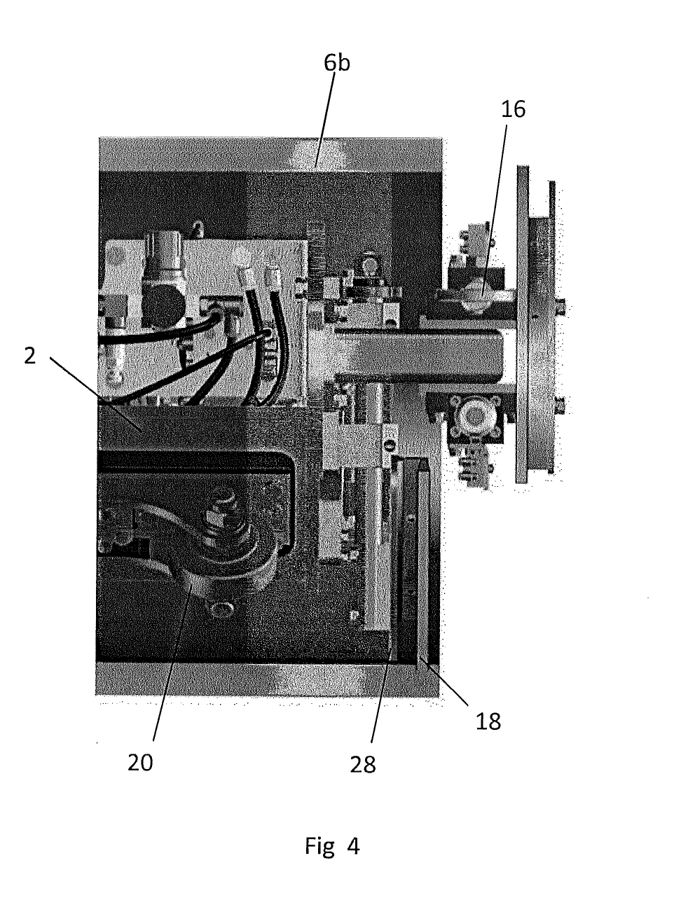

Turning to FIG. 4, when the swabbing machine 2 reaches the second end 6b of the pipe length the pneumatic logic system (not shown) onboard the swabbing machine 2 changes the direction in which the swabbing machine is propelled by the pneumatic motor 3. The swabbing machine 2 now travels in a second direction D2 as indicated by the arrow in FIG. 1a.

A pneumatic sensor 16 is mounted at one extremity of the swabbing machine. The pneumatic sensor 16 exits the far end of the pipe 6b ahead of the main body of the swabbing machine 2. The pneumatic sensor 16 provides a signal to the pneumatic logic system that the swabbing machine 2 has reached the second end of the pipe 6b causing the logic system to switch the direction of propulsion from D1 to D2.

An encoder (not shown) is provided on the hose reel 14 to count the number of rotations of the reel 14. Knowing the number of rotations of the reel 14 allows the amount of hose 24 payed out to be calculated. The amount of hose 24 payed out corresponds to the distance traveled by the swabbing machine 2 inside the pipe 6. In the event that the pneumatic sensor 16 fails the swabbing machine 2 is stopped once a maximum distance traveled is reached thereby preventing the swabbing machine 2 completely exiting the far end of the pipe length 6b.

The swabbing machine 2 cleans the inside of the pipe length 6 when travelling in the second direction D2. Pneumatic blowers 22 are connected to the swabbing machine 2 at the opposite end of the machine to the pneumatic sensor 16. In the present embodiment six blowers 22 are provided in a circular array symmetrical about the longitudinal axis of the swabbing machine 2. A semi-circular brush 18 and a semi-circular scraper 28 (both shaped to ensure contact over a substantial portion of the circumference of the curved inner surface of the pipe length 6) are moveably mounted on the swabbing machine 2 at the opposite end of the machine to the blowers 22.

When the pneumatic logic system receives the signal that the second end of the pipe length 6b has been reached the logic system lowers the brushes 18 and scrapers 28 into contact with the inner surface of the pipe length 6. The pneumatic blowers 22 are also switched on. The direction in which the pneumatic blowers 22 point may be controlled by the pneumatic logic system during the cleaning process. Once the cleaning apparatus (brushes 18, scrapers 28 and blowers 22) has been engaged or switched on the swabbing machine 2 is propelled in direction D2 along the pipe length 6, cleaning as it goes. The speed of travel in the second direction D2 is less than the speed of travel in the first direction D1 as a result of the extra resistance generated by the engagement of the cleaning apparatus with the inside surface of the pipe length.

The aspirator 8 provides suction to the garage 4 via an outlet located in the base of the garage 30. As the swabbing machine 2 cleans the inside of the pipe length 6 loose debris such as dust, flux left over from the welding process and slag are driven along the pipe length 6 by the brushes 18, scrapers 28 and blowers 22 mounted on the swabbing machine 2. The vacuum generated by the aspirator 8 draws this debris out of the pipe length 6 via the garage 4 and the aspirator hose 12. The air containing this debris may be passed through a filtration unit (not shown) prior to being returned to the atmosphere.

After travelling from the second end of the pipe length 6b to the first end of the pipe length 6a the swabbing machine 2 continues into the garage 4. The garage 4 is then moved away from the pipe length 6 back to its original position P1 as in FIG. 1a. The provision of aspiration to the garage 4 and pressurised air to the swabbing machine 2 is stopped.

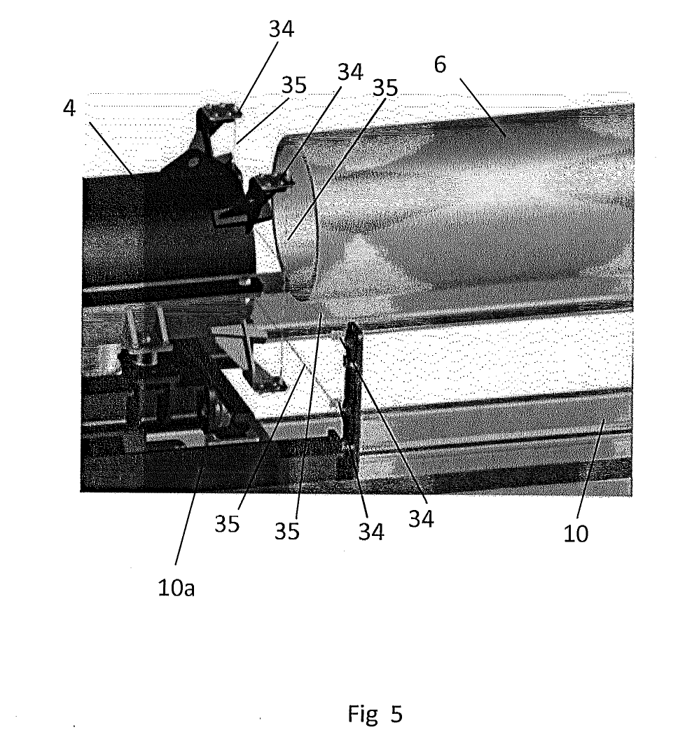

FIG. 5 shows a close-up of the garage 4 and first end of the pipe length 6a while the garage 4 is being aligned to the pipe length end. Four photo-cells 34 are provided, two photo-cells 34 on the garage 4 and two on the garage support frame 10a. Light beams 35 extend between the photo-cells 34 in FIG. 5. A control system uses the signal from the photo-cells 34 to align the garage 4 with the pipe length end 6a without operator input.

The automation of (i) the alignment of the garage 4 with pipe length end 6a, (ii) the switching of the direction of travel of the swabbing machine 2 when the far end of the pipe length 6b is reached, and (iii) the engagement of the cleaning apparatus, allows the cleaning cycle to be carried out without substantial operator intervention.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A method of cleaning the inside of a pipe length comprising at least one welded joint wherein the method comprises:
providing a swabbing machine at a first end of the pipe length, and
propelling the swabbing machine along the inside of the pipe length in a first direction away from the first end of the pipe length,
wherein the swabbing machine comprises a motor and the swabbing machine is propelled in the first direction by the motor.

2. A method according to claim 1, wherein the method comprises:
propelling the swabbing machine along the inside of the pipe length in a second direction, opposite to the first direction,
wherein the swabbing machine is propelled in the second direction by the motor.

3. A method according to claim 1, wherein the motor is a pneumatic motor.

4. A method according to claim 1 wherein the pipe length has a second end opposite the first end and the method comprises:
propelling the swabbing machine along the inside of the pipe length, in the first direction, from the first end of the pipe length to the second end of the pipe length, and
propelling the swabbing machine along the inside of the pipe length, in the second direction, from the second end of the pipe length to the first end of the pipe length,
wherein the swabbing machine comprises a sensor which detects the swabbing machine reaching the second end of the pipe.

5. A method according to claim 4, wherein the sensor is a pneumatic sensor.

6. A method according to claim 4, wherein the swabbing machine comprises a logic system which switches the direction in which the motor propels the swabbing machine from the first direction to the second direction in response to a signal from the sensor.

7. A method according to claim 6, wherein the logic system is a pneumatic logic system.

8. A method according to claim 2, whereby the swabbing machine cleans the inside of the pipe length when travelling in the second direction.

9. A method according to claim 8, wherein the swabbing machine cleans with one or more of a scraper, a brush and a pneumatic blower.

10. A method according to claim 1, wherein the swabbing machine is provided in a garage and the method comprises:
aligning the garage with the first end of the pipe length prior to propelling the swabbing machine in the first direction out of the garage and along the inside of the pipe length.

11. A method according to claim 1, wherein the method comprises:
generating suction at the first end of the pipe length while propelling the swabbing machine in the first direction.

12. A method according to claim 1, wherein the method comprises:
generating suction at the first end of the pipe length while propelling the swabbing machine in the second direction.

13. A method according to claim 1, wherein the pipe length to be cleaned is substantially horizontal.

14. A method according to claim 1, wherein a substantial portion of the pipe cleaning method is executed simultaneously with Non-Destructive Testing (NDT) of the at least one welded joint.

15. A method according to claim 1, wherein the swabbing machine travels at a first speed in the first direction and a second speed in the second direction, the first speed being greater than the second speed.

16. A swabbing machine for cleaning the inside of a pipe length including at least one welded joint wherein the swabbing machine comprises a motor arranged to propel the swabbing machine when the swabbing machine is inside the pipe length.

17. A swabbing machine according to claim 16, wherein the motor is a pneumatic motor.

18. A swabbing machine according to claim 16, wherein the motor is operable to propel the swabbing machine in a first direction and a second, opposite direction, along the pipe length.

19. A swabbing machine according to claim 16, wherein the swabbing machine comprises at least one wheel operably connected to the motor and operable to engage with the inside of the pipe length so that the motor drives the at least one wheel to propel the swabbing machine.

20. A swabbing machine according to claim 16, wherein the swabbing machine further comprises at least one scraper operable to clean the inside of the pipe length.

21. A swabbing machine according to claim 16, wherein the swabbing machine comprises at least one brush operable to clean the inside of the pipe length.

22. A swabbing machine according to claim 16, wherein the swabbing machine comprises at least one pneumatic blower operable to clean the inside of the pipe length.

23. A swabbing machine according to claim 16, wherein the swabbing machine comprises a logic system arranged to control the direction of travel of the swabbing machine.

24. A swabbing machine according to claim 23, wherein the logic system is a pneumatic logic system.

25. A swabbing machine according to claim 23, wherein the logic system comprises a sensor arranged to detect when the swabbing machine has reached the distal end of the pipe length.

26. A swabbing machine according to claim 25, wherein the sensor is pneumatic sensor.

27. A swabbing machine according to claim 23, wherein the logic system is arranged to control the speed of travel of the swabbing machine within the pipe length.

28. A swabbing machine according to claim 23, wherein the logic system is arranged to control the engagement and disengagement of the cleaning apparatus with the inside of the pipe.

29. A swabbing machine system for cleaning the inside of a pipe length having at least one welded joint, the swabbing machine system comprising:
a swabbing machine according to claim 16;
a swabbing machine garage for holding the swabbing machine when not in use, and
a drive system arranged to move the garage, so as to align the garage with the end of the pipe length so that the swabbing machine can be delivered to the pipe length.

30. A swabbing machine system according to claim 29, wherein the swabbing machine system comprises at least one sensor arranged to detect the location of the pipe length relative to the garage.

31. A swabbing machine system according to claim 29, wherein the swabbing machine system comprises an aspirator connected to the garage so as to provide suction at the end of the pipe length.

32. A swabbing machine system according to claim 29, wherein the motor is a pneumatic motor and the swabbing machine system comprises:
a hose connected to the swabbing machine so as to deliver a supply of pressurised gas to the pneumatic motor.

33. A swabbing machine for cleaning the inside of a pipe length, the swabbing machine comprising a pneumatic motor or a hydraulic motor and a pneumatic control system or a hydraulic control system, and wherein the swabbing machine does not comprise any electronic components.

34. A pipe-laying vessel, equipped with a swabbing machine according to claim 16.

35. A method of laying a pipeline, the method including a method of cleaning the inside of a pipe length comprising at least one welded joint according to claim 1.

36. (canceled)

37. (canceled)

38. (canceled)

39. A method of cleaning the inside of a pipe length for laying as part of a pipeline for use in the oil and gas industry, the pipe length comprising at least one welded joint, a first end and a second end opposite the first end and wherein the method comprises:
providing a swabbing machine at a first end of the pipe length,
propelling the swabbing machine along the inside of the pipe length, in a first direction, from the first end of the pipe length to the second end of the pipe length, and
propelling the swabbing machine along the inside of the pipe length, in a second direction, from the second end of the pipe length to the first end of the pipe length, and
wherein the swabbing machine comprises a motor and the swabbing machine is propelled in the first direction and the second direction by the motor and
wherein the swabbing machine comprise a sensor which detects the swabbing machine reaching the second end of the pipe.

40. A swabbing machine for cleaning the inside of a pipe length for laying as part of a pipeline for use in the oil and gas industry, the pipe length including at least one welded joint, the swabbing machine comprising a motor arranged to propel the swabbing machine in a first direction and a second, opposite, direction along the pipe length when the swabbing machine is inside the pipe length and a sensor arranged to detect when the swabbing machine has reached the distal end of the pipe length.
